(19) United States
(12) Patent Application Publication
(10) Pub. No.: US 2020/0162807 A1
(43) Pub. Date: May 21, 2020

(54) HEADPHONE CHARGING APPARATUS

(71) Applicant: ESI Cases & Accessories, New York, NY (US)

(72) Inventor: Kwangpyo LIM, New York, NY (US)

(21) Appl. No.: 16/285,665

(22) Filed: Feb. 26, 2019

Related U.S. Application Data
(63) Continuation-in-part of application No. 29/681,437, filed on Feb. 26, 2019.
Application No. 29/681,437 is a continuation-in-part of application No. 29/676,821, filed on Jan. 15, 2019.
Application No. 29/676,821 is a continuation-in-part of application No. 29/670,951, filed on Nov. 21, 2018.

(51) Int. Cl. H04R 1/10; H01R 13/62; H01R 24/60

(52) U.S. Cl. CPC H04R 1/1025; H01R 24/60; H01R 13/6205; H04R 1/1008

(57) ABSTRACT

A headphone charging apparatus having a support structure that supports at least a portion of a pair of headphones according to a contour feature of the pair of headphones, a magnetic connector interface disposed at a location corresponding to a power connector port of the pair of headphones when placed on the support structure, and a power connector port coupled to the magnetic connector port, the power connector port adapted to connect to an external power source.

### CROSS-REFERENCE TO RELATED APPLICATION

The present application is a continuation-in-part of U.S. patent application Ser. No. 29/670,951, filed Nov. 21, 2018, U.S. patent application Ser. No. 29/676,821, filed Jan. 15, 2019, and U.S. patent application Ser. No. 29/681,437, filed Feb. 26, 2019, the entire contents of each of which are incorporated by reference herein.

### FIELD OF THE INVENTION

The present invention relates to an apparatus for holding wireless headphones and for charging the headphones without requiring the user to directly connect the headphones to a charger cord provided with the headphones.

### BACKGROUND OF THE INVENTION

Headphones, earphones, and the like, for listening to music, audiobooks, etc., have traditionally been wired devices with audio jacks for connecting to music players, portable electronic devices—for example, cellular telephones such as the Apple iPhone, Samsung Galaxy, and the like. Such wired headphones were usually passive peripherals that relied upon the devices to which they were connected—music players, etc.—for power and operation.

More recently, with the development of short distance wireless communications, such as under the Bluetooth® standard, battery-powered wireless headphones have become commonplace. Such wireless headphones would pair and communicate with particular electronic devices for receiving audio signals via wireless communications to be reproduced in the headphones. Given their independent operation without a direct powered connection to the electronic devices, these wireless headphones require their own power source for operation, usually by a rechargeable battery. In most cases, wireless headphones are provided with a detachable wire connector, such as a micro USB connector and the like, that serves the dual purpose of charging the headphones by connecting to a power source and, optionally by connecting to an electronic device, providing a data connection to the electronic device while they are being recharged. There are also wall plug USB connectors for dedicated and, in some cases, fast charging of the wireless headphones.

### SUMMARY OF THE INVENTION

While USB data connection and charging for wireless headphones provide for a convenient means for maintaining use of the headphones while charging their batteries, frequent connections in this manner would defeat the wireless feature of the headphones. As such, users are usually advised to charge their headphones overnight so that they can start a day with fully-charged headphones for maximized use without a wired connection.

FIGS. 12A and 12B are bottom views of left channel earpieces of respective wireless headphones 1200a and 1200b. As shown in FIGS. 12A and 12B, a conventional pair of wireless headphones 1200a/1200b is usually provided with a connector port 1205 (for example, a micro USB connector port) on the bottom portion of one of the earpieces (hereinafter also referred to as ear cups) 1210. Therefore, the pair of headphones would usually be placed on its side, on a tabletop and the like, with a USB wire connected to connector port 1205. This manner of recharging the wireless headphones is unsightly and presents a risk for damaging delicate parts of the headphones by being simply placed on a surface without support. In addition, by placing the pair of headphones on its side, its footprint on the surface is maximized.

In view of the above, there is a need for a convenient and tidy manner for stowing and charging wireless headphones when they are not in use—for example, overnight.

According to an exemplary embodiment of the invention, a headphone charging apparatus comprises a support structure that supports at least a portion of a pair of headphones according to a contour feature of the pair of headphones, a magnetic connector interface disposed at a location corresponding to a power connector port of the pair of headphones when placed on the support structure, and a power connector port coupled to the magnetic connector port, the power connector port adapted to connect to an external power source.

According to an exemplary embodiment of the invention, the headphone charging apparatus comprises a magnetic connector inserted to the power connector port of the pair of headphones.

According to an exemplary embodiment of the invention, the magnetic connector comprises a surface having a magnetic polarity that is opposite to a magnetic polarity of a surface of the magnetic connector interface.

According to an exemplary embodiment of the invention, the support structure comprises a hanger rod and the contour feature of the pair of headphones is a headband.

According to an exemplary embodiment of the invention, the hanger rod is connected to a column having a height adjustment mechanism that adjusts the height of the hanger rod.

According to an exemplary embodiment of the invention, the support structure comprises one or more first indentations on a top surface of the headphone charging apparatus and the contour feature is a shape of a bottom portion of the pair of headphones.

According to an exemplary embodiment of the invention, the top surface incorporates a removable plate that is detachable from the headphone charging apparatus.

According to an exemplary embodiment of the invention, another removable plate can be detachably attached to the headphone charging apparatus, the another removable plate having one or more second indentations that are shaped differently from the one or more first indentations.

Other features and advantages of the present invention will become readily apparent from the following detailed description and the accompanying drawings.

### BRIEF DESCRIPTION OF THE DRAWINGS

FIG. 1 is a perspective view of an adaptable headphone charging stand in accordance with an exemplary embodiment of the invention.

FIGS. 2A and 2B are perspective views illustrating headphone connectors according to exemplary embodiments of the invention.

FIG. 3 is a diagram illustrating a pair of headphones being hung on the adaptable headphone charging stand of FIG. 1 in accordance with an exemplary embodiment of the invention.

FIG. 4 is a front view of the adaptable headphone charging stand of FIG. 1 to more clearly illustrate the location of a connector interface according to an exemplary embodiment of the invention.

FIGS. 5A, 5B, and 5C are perspective, back and, top views, respectively, of a headphone charging cradle in accordance with another exemplary embodiment of the invention.

FIG. 6 is a diagram illustrating a pair of headphones being placed on the headphone charging cradle of FIGS. 5A, 5B, and 5C in accordance with the another exemplary embodiment of the invention.

FIGS. 7A and 7B are perspective and top views, respectively, of a headphone charging cradle according to an exemplary embodiment of the invention.

FIG. 8 is a diagram illustrating a pair of headphones being placed on the headphone charging cradle of FIGS. 7A and 7B in accordance with an exemplary embodiment of the invention.

FIG. 9 is a perspective view of a headphone charging stand in accordance with another exemplary embodiment of the invention.

FIG. 10 is a side view of the headphone charging stand of FIG. 9.

FIG. 11 is a diagram illustrating a pair of headphones being hung on the headphone charging stand of FIG. 9 and a mobile device being placed on a wireless charging platform on the adaptable headphone charging stand of FIG. 9.

FIGS. 12A and 12B are diagrams illustrating a pair of wireless headphones for use with the headphone charging stand and the headphone charging cradle according to exemplary embodiments of the invention.

The above and related objects, features and advantages of the present invention will be more fully understood by reference to the following, detailed description of the preferred, albeit illustrative, embodiment of the present invention when taken in conjunction with the accompanying figures, wherein:

### DETAILED DESCRIPTION

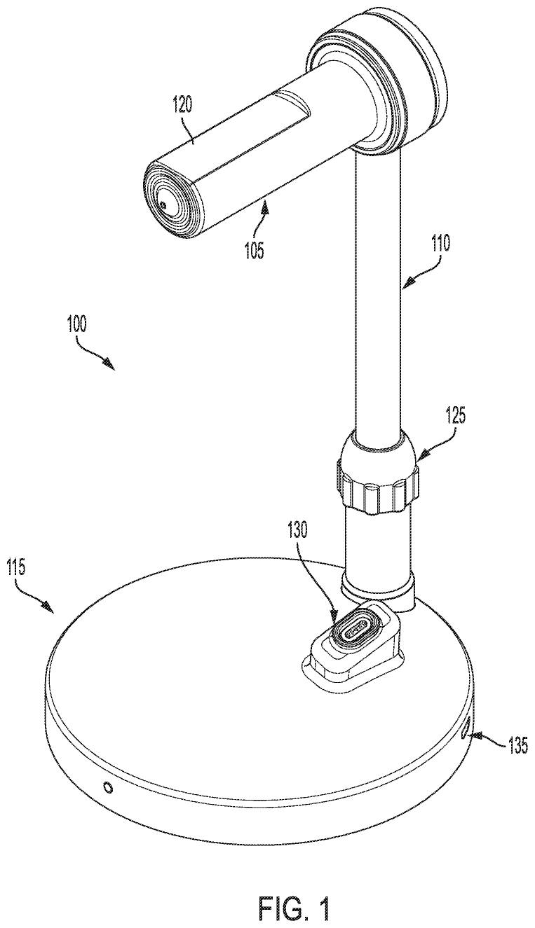

FIG. 1 is a perspective view of an adaptable headphone charging stand 100 in accordance with an exemplary embodiment of the invention. As shown in FIG. 1, charging stand 100 may comprise a hanger rod 105 extending orthogonally from a column 110 over a base 115. Base 115 may incorporate a weighted material to provide stand 100 with a lower center of gravity, thus improving its stability when a pair of headphones is hung on rod 105. Rod 105 may comprise a flattened section 120 to provide a relatively stable surface onto which a headband of a pair of headphones may be hung. In addition, column 110 may incorporate a height adjustment mechanism 125 to provide for adjusting the height of hanger rod 105. According to an alternative embodiment of the invention, stand 100 may incorporate a column 110 having a predetermined custom height that is specifically designed for particular types or brands of headphones—for example, those marketed under the brands Bose, Beats, etc., respectively—without the height adjustment mechanism 125.

According to an exemplary embodiment of the invention, stand 100 incorporates a magnetic connector (charging) interface 130 that is disposed at a location of base 115 that corresponds to a data/power connector port—for example, a USB-C connector port—of a pair of wireless headphones.

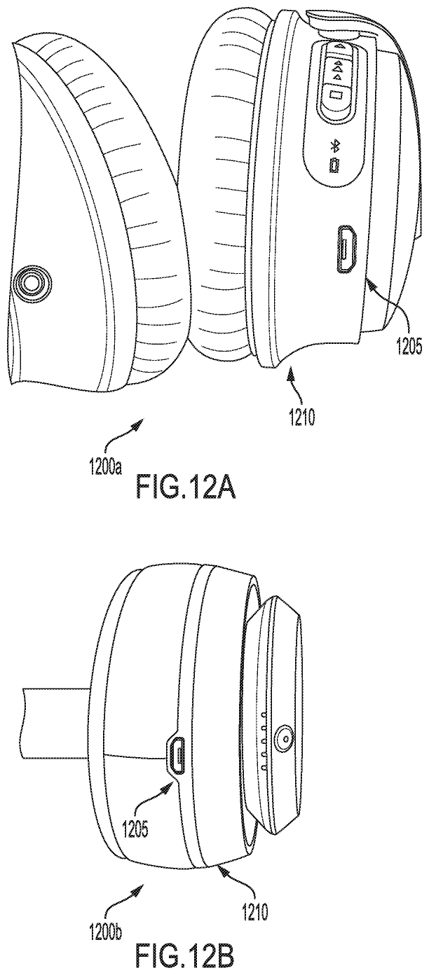

In a majority of wireless headphones, such as headphones 1200 shown in FIG. 12, a power and data connector (1205) is provided on a bottom portion of one of the ear cups (1210). Such a connector (1205) is used for charging an onboard battery of the wireless headphones (1200) and, optionally, maintaining use during such charging and/or providing firmware updates to the headphones (1200). The most common standard for such connectors in wireless headphones at the present time is the micro USB standard, whereby a pair of wireless headphones may be connected to a power source to recharge its batteries via a cord connection through the micro USB connector.

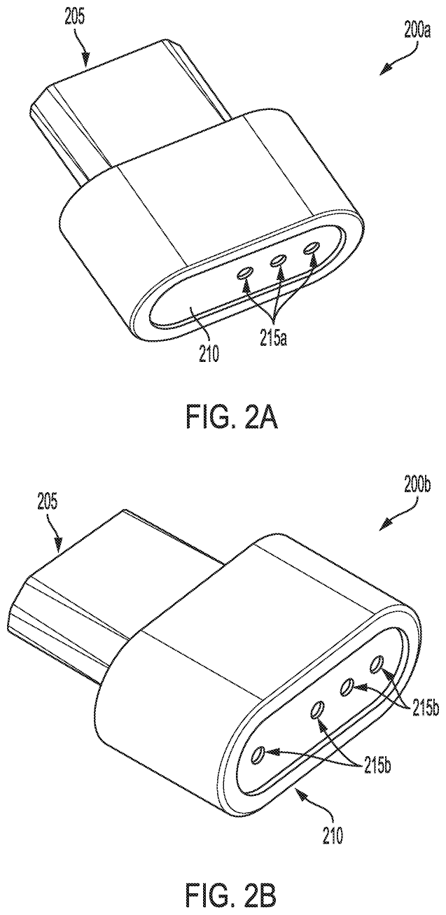

FIGS. 2A and 2B are perspective views illustrating headphone connectors 200a and 200b according to exemplary embodiments of the invention. Connectors 200a and 200b each incorporates a standard-based connection portion 205 for inserting to a standard (e.g., micro USB) connector (e.g., 1205) of a pair of wireless headphones (e.g., 1200). On an opposite end thereof, the connectors 200a and 200b incorporate a magnetic surface 210 that comprises a number of connector pins 215a and 215b, respectively, that provide for connections through corresponding pins within connection portion 205 to the wireless headphones. FIG. 2A shows three (3) pins 215a and FIG. 2B illustrates four (4) pins 215b arranged asymmetrically for providing a power charging connection in accordance with exemplary embodiments of the invention.

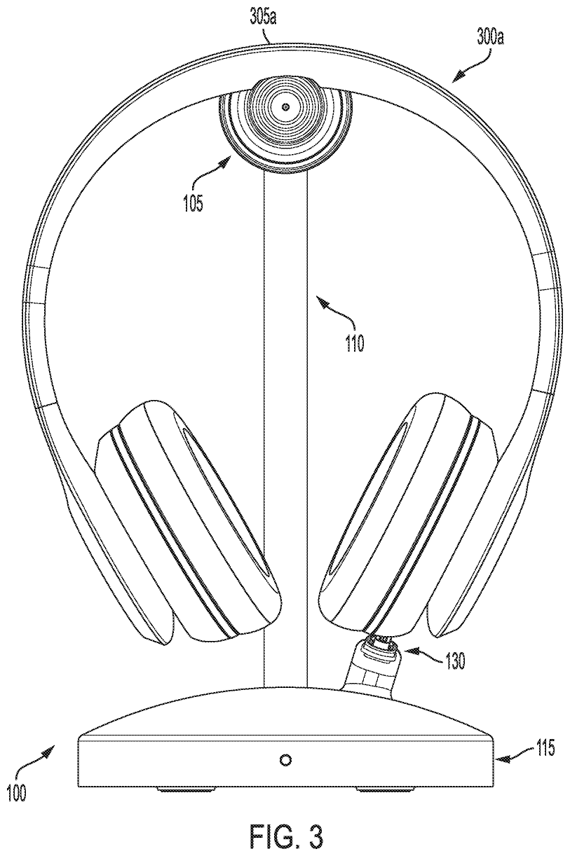

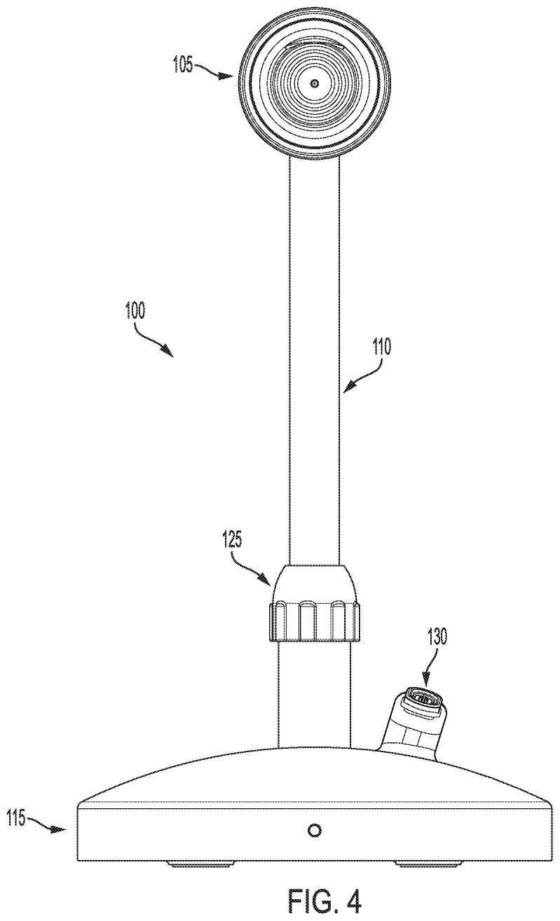

Correspondingly, referring back to FIG. 1, connector interface 130 of stand 100 comprises a magnetic portion having an opposite polarity to magnetic surface 210 of connectors 200a and 200b so as to provide for an attractive force thereto. In addition, connector interface 130 may comprise either three (3) or four (4) pins in a corresponding arrangement in alignment with connector 200a or 200b so as to provide a power connection thereto. Thus, as illustrated in FIG. 3, a user may hang a pair of wireless headphones 300a—by placing headband 305a (contour feature) onto hanger rod 105—with either connector 200a or 200b inserted to its micro USB port and the magnetic attraction between connector interface 130 and connector 200a/200b provides a convenient battery charging connection, without requiring the user to deliberately make the charging connection to a power cord. Instead, a power cord—such as one provided with the wireless headphones, and the like—may be semi-permanently connected to stand 100 at connector port 135—which may be a micro USB connector port, and the like, that is electrically coupled to connector interface 130—to a power source. FIG. 4 is a front view of stand 100 to more clearly illustrate the location of connector interface 130 according to an exemplary embodiment of the invention. Again, stand 100 may incorporate a height adjustment mechanism 125—for example, a rotatable threaded position lock and the like—to allow for adjusting the height of hanger rod 105 to accommodate headphones of various sizes for an appropriate hanging fit for connecting connector 200a/200b to connector interface 130. Advantageously, the magnetic connection between the headphones and stand 100, via connector 200a/200b and connector interface 130, removes the need for repeatedly connecting and disconnecting the headphones to a power cord for recharging—thus significantly reducing the repeated mechanical stress to, and thereby improving the longevity of, the power cord.

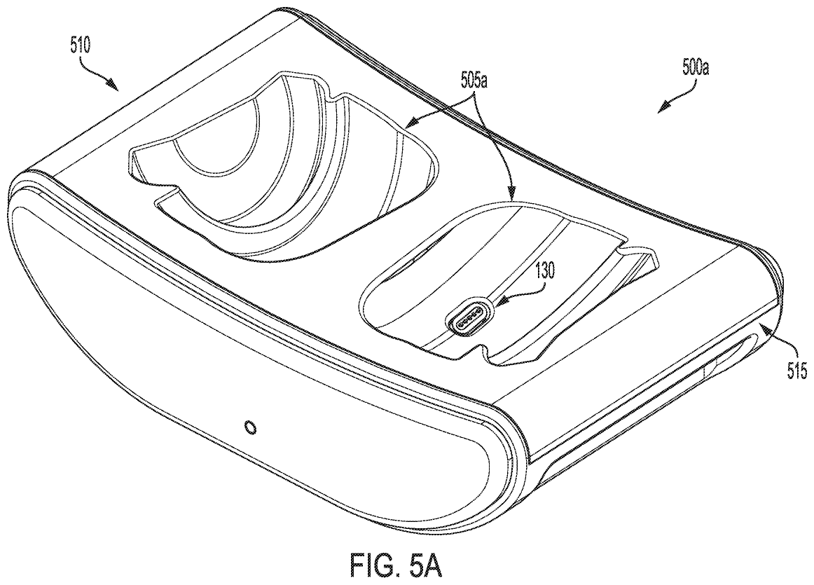

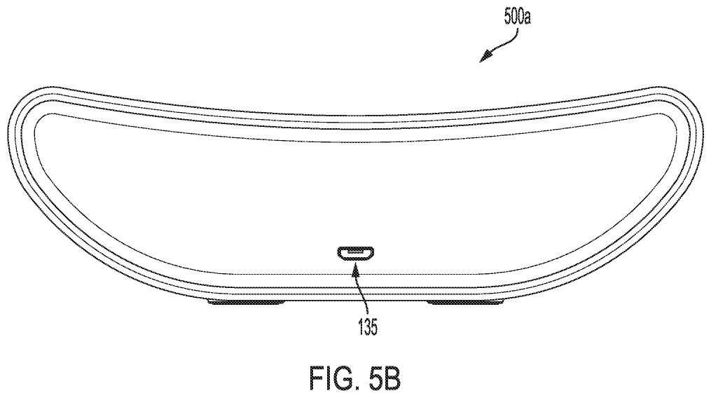

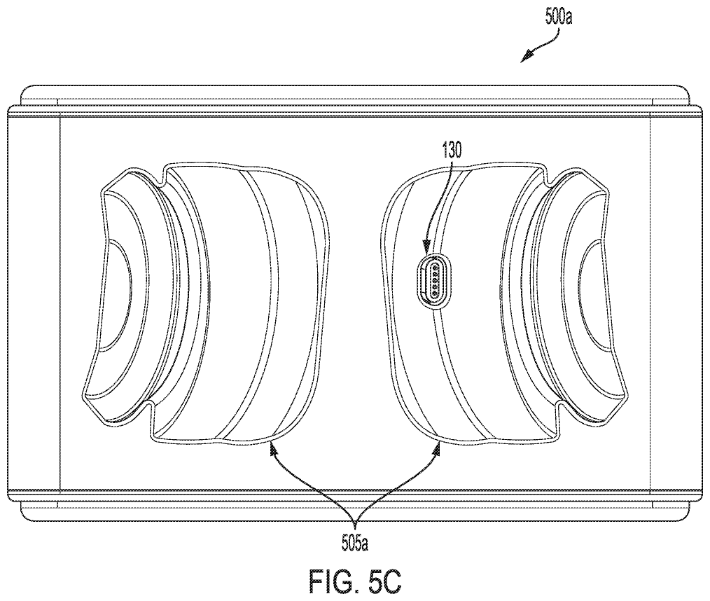

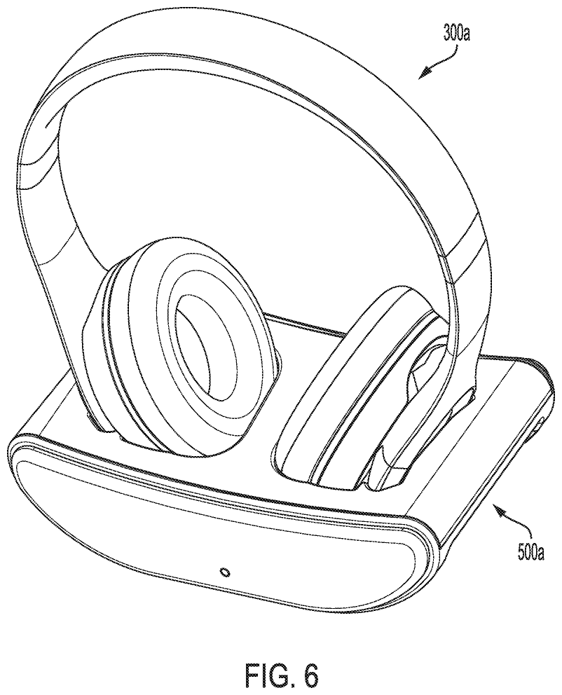

FIGS. 5A, 5B, and 5C are perspective, back and, top views, respectively, of a charging cradle 500a in accordance with an exemplary embodiment of the invention. As shown in these figures, a cradle 500a having indentations 505a on a top surface 510 thereof for receiving the ear cups of a pair of headphones provides for convenient placement and recharging of the headphones in a similar manner to stand 100 described above. Indentations 505a may be shaped according to the contours of particular types or brands of headphones—for example, those marketed under the brands Bose, Beats, etc., respectively—for fitting the ear cups so that the headphones may be placed on cradle 500a in a stable manner. For example, FIG. 6 illustrates a pair of headphones 300a being placed on cradle 500a with bottom portions (contour feature) of the ear cups fitted into indentations 505a, as described above. Referring back to FIGS. 5A and 5C, one or more of the indentations 505a may incorporate magnetic connector interface 130 at a location that corresponds to the position at which connector 200a/200b would be connected to headphones 300a. Thus, in a manner similar to stand 100, cradle 500a provides for a magnetic connection to connector 200a/200b for recharging headphones 300a while it is placed on cradle 500a. As shown in FIG. 5B, cradle 500a may incorporate a connector port 135 that conforms to the power connector of headphones 300a—such as micro USB and the like—for connecting to a power source. Thus, similar to stand 100, cradle 500a serves as a conduit for recharging headphones 300a via a connection to a power source at connector port 135, which is coupled to connector interface 130, the magnetic attraction between connector interface 130 and connector 200a/200b providing a convenient battery charging connection without requiring the user to deliberately make the charging connection to the power cord. Advantageously, the magnetic connection between the headphones 300a and cradle 500a, via connector 200a/200b and connector interface 130, removes the need for repeatedly connecting and disconnecting the headphones 300a to a power cord for recharging—thus significantly reducing the repeated mechanical stress to, and thereby improving the longevity of, the power cord. In addition, the magnetic connection between connector 200a/200b and connector interface 130 may also stabilize the headphones 300a while it is placed on cradle 500a. In correspondence with stand 100 described above, cradle 500a may also incorporate a weighted material to lower its center of gravity and further improve stability for placing headphones 300a thereon. Thus, headphones 300a can be neatly placed on cradle 500a for recharging.

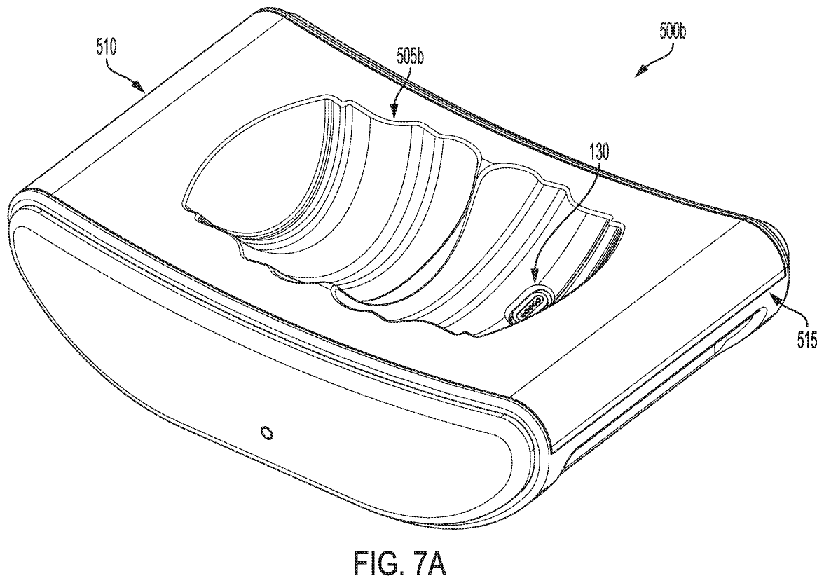

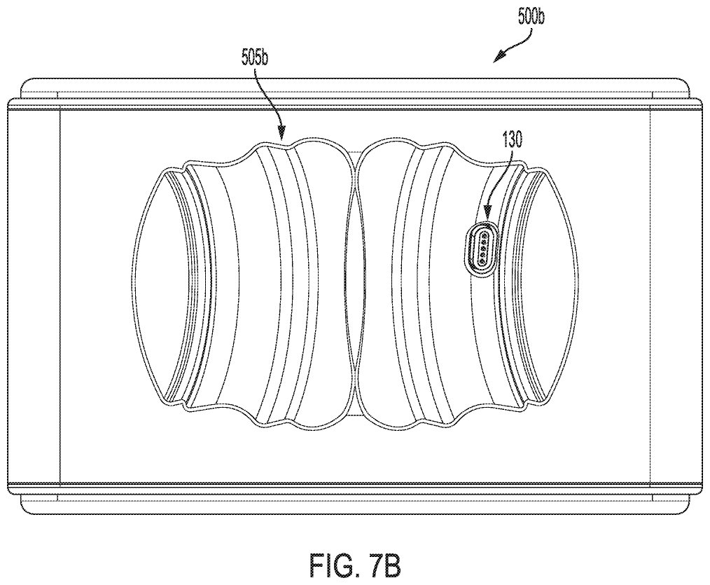

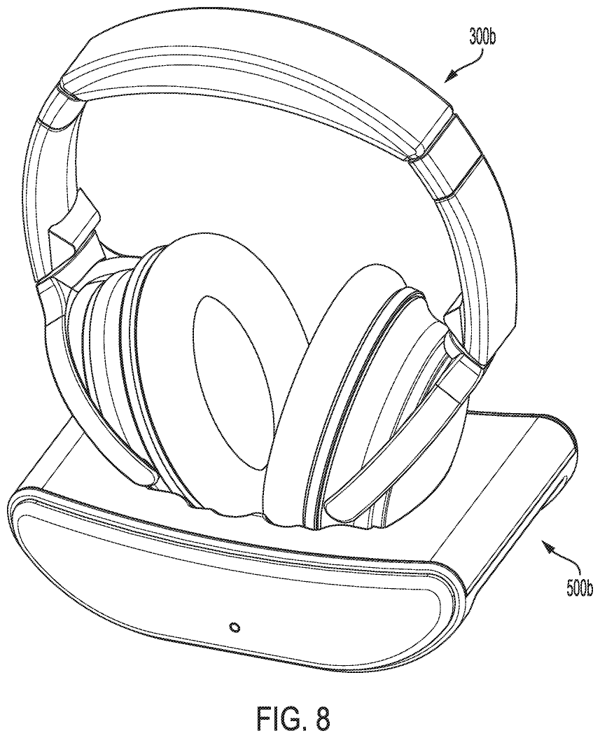

FIGS. 7A and 7B are perspective and top views, respectively, of a charging cradle 500b according to an exemplary embodiment of the invention. As shown in FIGS. 7A and 7B, charging cradle 500b may comprise a top surface 510 having a shaped indentation 505b that conforms to the contours of a pair of headphones (e.g., the bottom portions of the ear cups, or “contour feature”) that are different from those of charging cradle 500a shown in FIGS. 5A-C. FIG. 8 illustrates headphones 300b, which are shaped differently from headphones 300a, being placed on cradle 500b for recharging. Referring now to FIGS. 5A and 7A, top surface 510 of cradles 500a and 500b may be incorporated by a removable plate such that it is interchangeable between indentations 505a and 505b. According to an exemplary embodiment of the invention, such a plate may be detachable at joint 515 shown in FIGS. 5A and 7A.

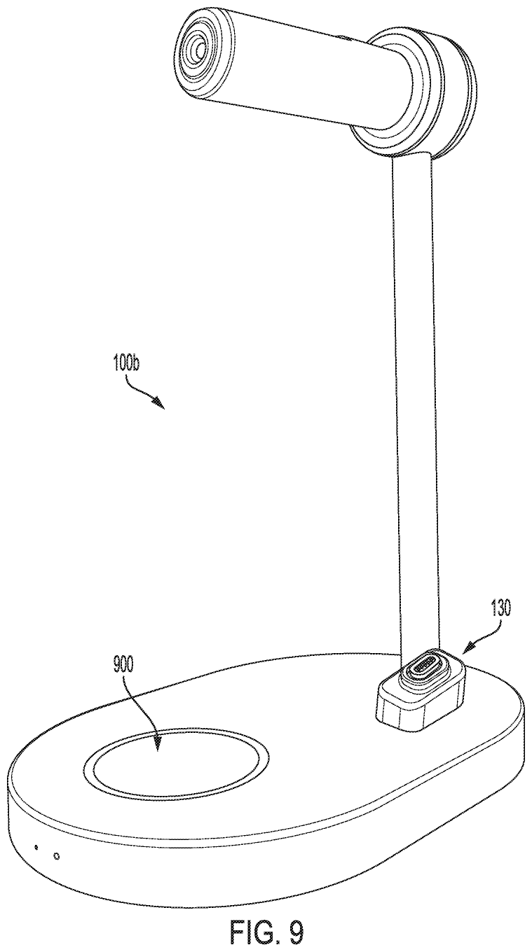

FIG. 9 is a perspective view of a headphone charging stand 100b in accordance with another exemplary embodiment of the invention. As shown in FIG. 9, headphone charging stand 100b incorporates a wireless charging platform 900. Within the housing of wireless charging platform 900 is electromagnetic circuitry that emits near-field electromagnetic signals to induce wireless charging circuitry of portable devices placed upon platform 900. The electromagnetic circuitry may be powered via connector port 135 and may comprise a trigger element that activates the electromagnetic circuitry upon detecting a portable device and/or its corresponding wireless charging circuitry in proximity to wireless charging platform 900. As an example, the so-called “Qi” standard for wirelessly charging portable electronic devices, which employs respective planar coils in portable devices and chargers, may be implemented for wireless charging platform 900.

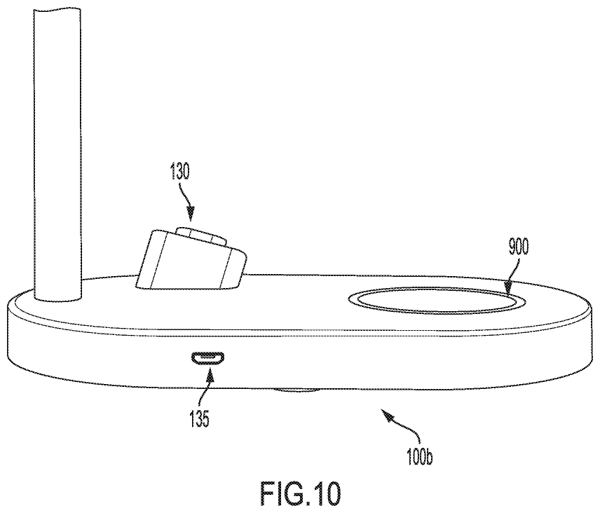

FIG. 10 is a side view of the adaptable headphone charging stand of FIG. 9. As illustrated in FIG. 10, headphone charging stand 100b incorporates connector port 135 for connecting to an external power source for powering both connector interface 130 and wireless charging platform 900.

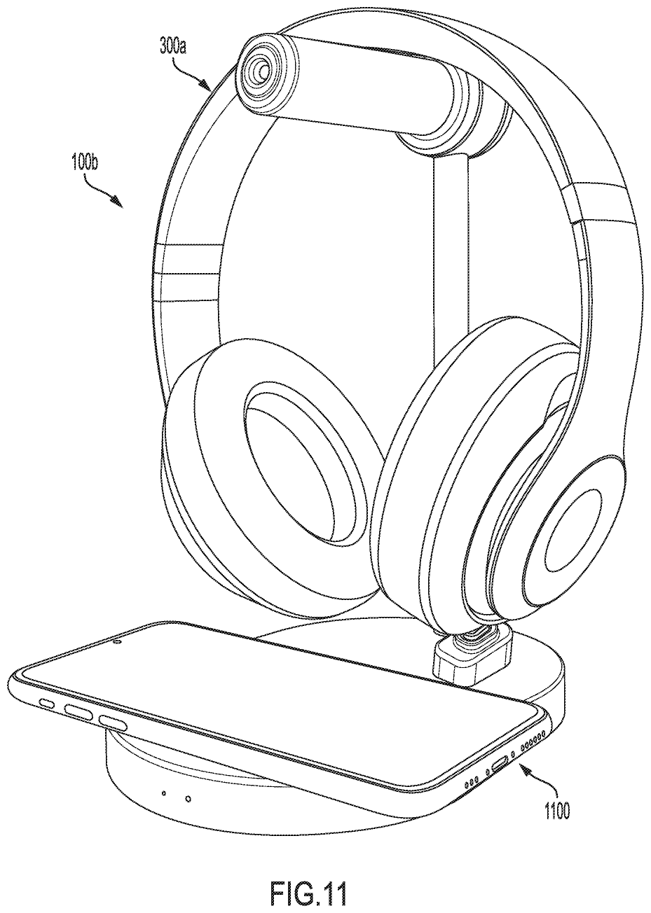

FIG. 11 is a diagram illustrating a pair of headphones 300a being hung on the headphone charging stand 100b and a mobile device 1100 being placed on wireless charging platform 900. As shown in FIG. 11, headphone charging stand 100b is configured such that headphones 300a can be hung for charging in the manner shown in FIG. 3 and described above, while at the same time mobile device 1100 can be placed on wireless charging platform 900 for wireless charging. The availability of concurrent charging for these devices that are often used together provides additional convenience to the user.

While in the foregoing specification a detailed description of specific embodiments of the invention was set forth, it will be understood that many of the details herein given may be varied considerably by those skilled in the art without departing from the spirit and scope of the invention.

1. A headphone charging apparatus, comprising:
a support structure that supports at least a portion of a pair of headphones according to a contour feature of the pair of headphones;
a magnetic connector interface disposed at a location corresponding to a power connector port of the pair of headphones when placed on the support structure; and
a power connector port coupled to the magnetic connector port, the power connector port adapted to connect to an external power source.

2. The headphone charging apparatus of claim 1, further comprising a magnetic connector inserted into the power connector port of the pair of headphones.

3. The headphone charging apparatus of claim 2, wherein the magnetic connector comprises a surface having a magnetic polarity that is opposite to a magnetic polarity of a surface of the magnetic connector interface.

4. The headphone charging apparatus of claim 1, wherein the support structure comprises a hanger rod and the contour feature of the pair of headphones is a headband.

5. The headphone charging apparatus of claim 4, wherein the hanger rod is connected to a column having a height adjustment mechanism that adjusts the height of the hanger rod.

6. The headphone charging apparatus of claim 1, wherein the support structure comprises one or more first indentations on a top surface of the headphone charging apparatus and the contour feature is a shape of a bottom portion of the pair of headphones.

7. The headphone charging apparatus of claim 6, wherein the top surface incorporates a removable plate that is detachable from the headphone charging apparatus.

8. The headphone charging apparatus of claim 7, further comprising another removable plate that is detachably attached to the headphone charging apparatus, the another removable plate having one or more second indentations that are shaped differently from the one or more first indentations.

9. The headphone charging apparatus of claim 1, further comprising a wireless charging platform that wirelessly charges a mobile device having wireless charging circuitry when placed on the wireless charging platform.

10. A headphone charging apparatus, comprising:
a hanger rod for hanging a pair of headphones by a headband thereof;
a magnetic connector interface disposed at a location corresponding to a power connector port of the pair of headphones when hung on the hanger rod; and
a power connector port coupled to the magnetic connector port, the power connector port adapted to connect to an external power source.

11. A headphone charging apparatus, comprising:
one or more indentations on a top surface that correspond to a shape of a bottom portion of a pair of headphones;
a magnetic connector interface disposed at a location in the one or more indentations corresponding to a power connector port of the pair of headphones when placed in the one or more indentations; and
a power connector port coupled to the magnetic connector port, the power connector port adapted to connect to an external power source.
